(19) United States
(12) Patent Application Publication
(10) Pub. No.: US 2007/0138352 A1
(43) Pub. Date: Jun. 21, 2007

(54) Method and apparatus for securing cables and the like

(75) Inventor: Maurus Logan, Elizabeth, NJ (US)

Correspondence Address: James J. Daley;c/o Medcount Systems, LLC, 30 Hillside Road, Elizabeth, NJ, 07208, US

(73) Assignee: Medcount Systems, L.L.C.

(21) Appl. No.: 11/302,182

(22) Filed: Dec. 12, 2005

(51) Int. Cl. F16L 3/12

(52) U.S. Cl. 248/74.3

(57) ABSTRACT

A securement member is provided for mounting a cable tie to a mounting panel. The cable tie is an elongate member having a head and a tail extending from the head and having a self-bias to a planar condition. The securement member comprises a rigid elongate body defining an aperture extending therethrough, the aperture being adapted to receive the tail and being dimensioned to frictionally engage the received tail, attaching the tail to the securement member. The frictional force is derived from a widthwise or heightwise component of the tail's self-bias to a planar condition. Force derived from the lengthwise component of the tail's self-bias to a planar condition may supplement the widthwise component in both attaching the tail to the securement member and in mounting the tie on a mounting panel.

### FIELD OF THE INVENTION

The present invention relates generally to securement apparatus and methods and pertains more particularly to securement apparatus using so-called “cable ties”.

### BACKGROUND OF THE INVENTION

For many years, the electrical cable industry has had the benefit of cable ties to encircle and ensnare groupings of conductors. Applicant's U.S. Pat. Nos. 3,022,557 and 3,047,945, now expired, respectively show examples of cable ties and tensioning apparatus for use in assembling cable ties and conductor groupings. As shown in these patents, cable ties are typically molded plastic members having a head portion and a tail portion extending from the head portion to a free end. The head portion typically includes a pawl member extending into a tail portion passage extending fully through the head portion. The tail portion is routed about the conductors to be ensnared and has serrations on one or both outer surfaces thereof designed to pass by the pawl member under the pulling pressure of a person or a pulling tool, the pawl retentively engaging the serrations to form a cable tie loop tightly encircling the conductors.

Where it is desired to mount a cable tie to a mounting panel, use is sometimes made of a so-called “mounting head tie”, such as are available from Thomas & Betts Corporation under the trademark “Catamount”. This cable tie is formed as above described, but further includes a mounting head integrally formed with the tie proper adjacent the tie head portion and defining a circular hole. Use of mounting head ties entails need for a stove bolt and nut, a flat washer and a lock washer. After the stove bolt is inserted through the mounting head hole, the flat washer and lock washer are then applied to the bolt. The bolt is then threaded into the nut and tightened.

An alternative to the foregoing apparatus is seen in a “Single-Bundle Mounting Base”, also available from Thomas & Betts Corporation under the registered trademark “Ty-Rap”. This device is an elongate nylon base, having end openings for receiving screws for mounting the base to a mounting panel and further openings intermediate the end openings. The end of a cable tie opposite the head portion is passed successively through the intermediate openings and the mounting screws are then applied to the base and threaded into openings in the mounting panel. Conductors are now applied to the cable tie and the tie is tightened about the conductors.

From applicant's perspective, use of the mounting head tie or the single-bundle mounting base is costly, labor intensive and inefficient in weight sensitive environments, such as aircraft, where lessening of the securement device weight converts into fuel saving, shortened take-off distances and extended flight mileage.

Lessened cost, labor intensity and weight than provided by the mounting apparatus above described is available, e.g., through the use of so-called “Push Mount Cable Ties” also sold by Thomas and Betts Corporation under the aforesaid Catamount trademark. This device includes an arrowed structure adjacent the cable tie head portion and formed integrally therewith. The arrowed structure is inserted into an opening in the mounting panel and the wings of the arrow spread apart, securing the cable tie to the mounting panel. From applicant's perspective, such alternative does not provide desired mounting securement strength.

Another approach to cable tie mounting of lessened labor intensity is seen in O'Grady U.S. Pat. No. 5,314,154, which discloses a cable tie having a head portion and a tail extending from the head portion, the tail having a self-bias to a planar configuration, and a securement member defining a single elongate slot for receiving the cable tie tail. Upon assembly of the securement member and the cable tie tail, the tail is folded upon itself and the securement member rotated into general alignment with the folded cable tie tail. The securement member is inserted into and through a mounting panel opening, whereupon the securement member, which has a length exceeding the diameter of the mounting panel opening, rotates into parallelism with the mounting panel and is urged against the mounting panel by the self-bias of the cable tie tail.

Applicant herein discloses another approach to cable tie mounting of lessened labor intensity in copending patent application Ser. No. 10/772,909, filed on Feb. 5, 2004 and entitled “METHOD AND APPARATUS FOR SECURING CABLES AND THE LIKE”. In that approach, applicant provides a method for use in assembling conductors with a mounting panel, comprising the steps of: (a) providing a cable tie having a head and a tail extending from the head, the tail having a self-bias to a planar condition; (b) attaching a securement member to the tail using the self-bias of the tail to render the securement member portable with the cable tie; (c) releasing the biased attachment of the securement member and the tail; and (d) attaching the securement member and the cable tie to the mounting panel using the self-bias of the tail.

In its preferred form, the securement member extends longitudinally with the tail and defining (1) first and second perimetrically bounded elongate apertures opening along their lengths into first and second opposed sides of the securement member and (2) a tail support portion longitudinally between the first and second apertures, the tail being deformed by the securement member from the planar configuration to have an arcuate portion facing the support portion of the securement member, first and second courses of the tail extending from the tail arcuate portion respectively through the first and second apertures and movable out of the first and second apertures, the self-bias of the tail biasing the securement member into engagement with the tail such that the securement member and the tail are attached with one another to be jointly portable.

### SUMMARY OF THE INVENTION

A primary object of the present invention is to provide simplified apparatus for mounting conductors on a mounting panel.

A more particular object of the present invention is to provide apparatus for mounting conductors on a mounting panel, wherein the apparatus is inexpensive, labor unintensive and efficient in weight sensitive environments.

In attaining the foregoing and other objects, in one aspect, the invention provides a securement member for mounting a cable tie to a mounting panel, the cable tie being an elongate member having a head and a tail extending from the head, the securement member comprising a rigid elongate body defining an aperture extending therethrough, the aperture being adapted to receive the tail longitudinally of the body and being of lesser dimension than a tail dimension in one of tail width and height to frictionally engage the received tail.

More particularly, in one aspect, the cable tie tail has a given transverse dimension (width) and a given thickness (height), the aperture receiving the tail having a width dimension less than the tail given transverse dimension and a height dimension at least equal to the tail height.

In another aspect, the cable tie tail has a given transverse dimension (width) and a given thickness (height), the aperture receiving the tail having a width at least equal to the transverse dimension of the tail and a height dimension less than the tail thickness.

The securement member aperture may be preformed to have the respective lesser width or height dimensions or may be so formed after the tail receives the tie tail.

In a further aspect, the body defines a further aperture extending therethrough also adapted to receive the tail, the further aperture having a height dimension at least equal to the tail thickness and a dimension transversely of the received tail at least equal to the tail given transverse dimension.

Further, longitudinally outermost margins of the first-mentioned and the further apertures may frictionally engage the received tail.

In its method aspect, the invention provides a method for use in assembling conductors with a mounting panel, comprising the steps of:

(a) providing a cable tie having a head and a tail extending from the head, the tail having a self-bias to a planar condition;

(b) attaching a securement member to the tail using the self-bias of the tail to render the securement member portable with the cable tie; and

(c) while retaining the biased attachment of the securement member and the tail, attaching the securement member and the cable tie to the mounting panel.

More particularly, the invention makes use of one of the widthwise or thickness components of the cable tie tail self-bias to a planar condition to attach the securement member to the cable tie.

The foregoing and other features of the invention will be further understood from the ensuing detailed description of preferred embodiments and practices and from the drawings, wherein like reference numerals identify like components throughout.

### DESCRIPTION OF THE DRAWINGS

FIG. 1 is a front elevation of a first embodiment of an assembly of a cable tie and a securement member in accordance with the invention.

FIG. 2 is a front elevation of the securement member of the FIG. 1 assembly.

FIG. 3 is a top plan view of FIG. 2.

FIG. 4 is a bottom plan view of FIG. 2.

FIG. 5 is a sectional view of the securement member of the FIG. 1 assembly as would be seen from plane V-V of FIG. 1.

FIG. 6 is a sectional view of the FIG. 1 assembly as would be seen from plane VI-VI of FIG. 1.

FIG. 7 is a sectional view of the FIG. 1 assembly as would be seen from plane VII-VII of FIG. 1.

FIG. 8 is a sectional view of the FIG. 1 assembly as would be seen from plane VIII-VIII of FIG. 1.

FIG. 9 is a perspective view of the FIG. 1 assembly, broken away and sectioned in part to show detail.

FIG. 10 is a view showing the FIG. 1 assembly in part and mounted on a mounting panel shown in section.

FIG. 11 is a perspective view showing an alternative securement member for use in the assemblies of FIG. 1 and FIG. 10.

FIG. 12 is a front elevation of a further embodiment of a securement member for use in practicing the invention.

FIG. 13 is a sectional view of the securement member of FIG. 12 as would be seen from plane XIII-XIII of FIG. 12.

FIG. 14 is a front elevation of an assembly of the securement member of FIG. 12 with a cable tie tail, shown in part.

FIG. 15 is a right side elevation of the assembly of FIG. 14.

FIG. 16 is a view showing the FIG. 14 assembly in an initial stage of being mounted on a mounting panel shown in section.

FIG. 17 is a view showing the FIG. 14 assembly fully mounted on a mounting panel shown in section.

FIG. 18 is a perspective view of a further assembly in accordance with the invention, broken away and sectioned in part to show detail.

FIG. 19 is a front elevation of the securement member of the FIG. 18 assembly.

### DETAILED DESCRIPTION OF PREFERRED EMBODIMENTS AND PRACTICES

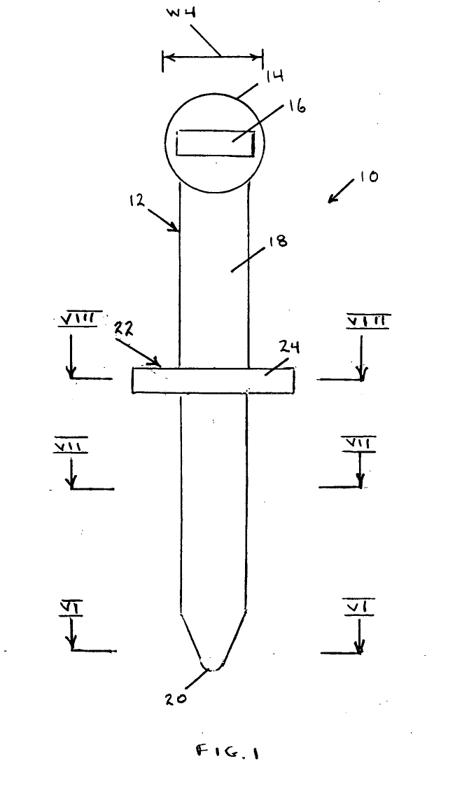

Referring to FIG. 1, assembly 10 of the invention includes cable tie 12, having head 14 with passage 16 extending therethrough and typically including a pawl (not shown) disposed in the passage. Cable tie tail 18 is formed integrally with head 14 and extends downwardly along the longitudinal axis of the elongate tail to tail free end 20, which is tapered as shown.

Securement member 22 is used for mounting cable tie 12 to a mounting panel.

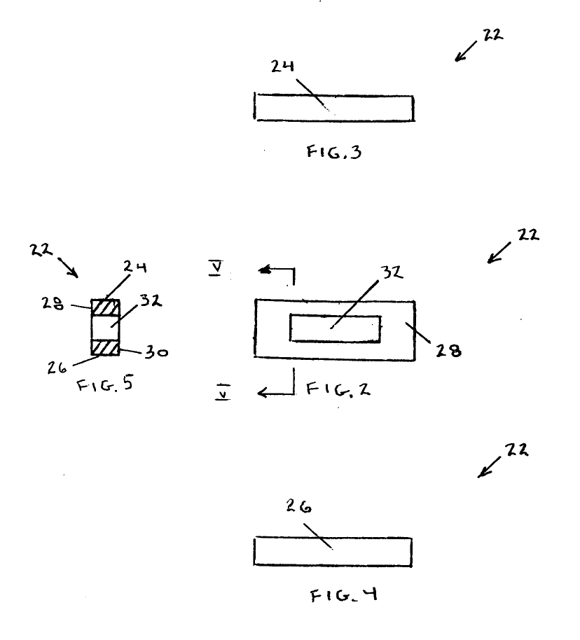

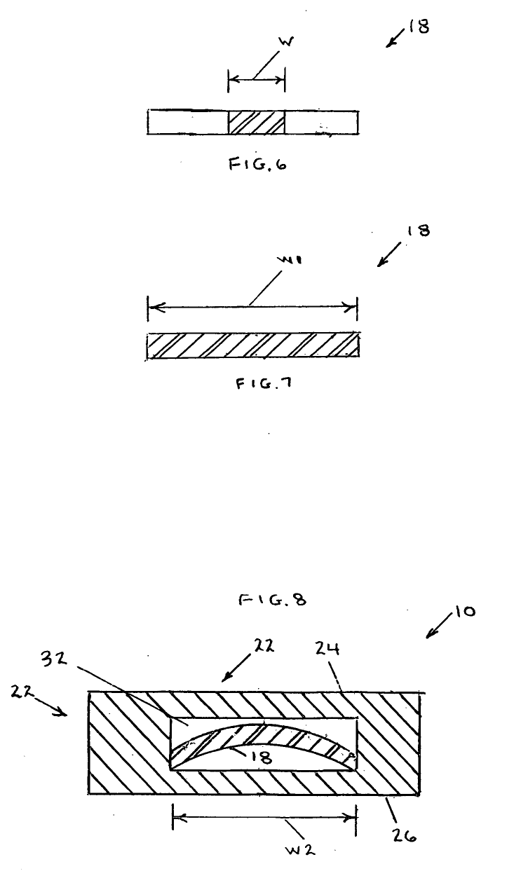

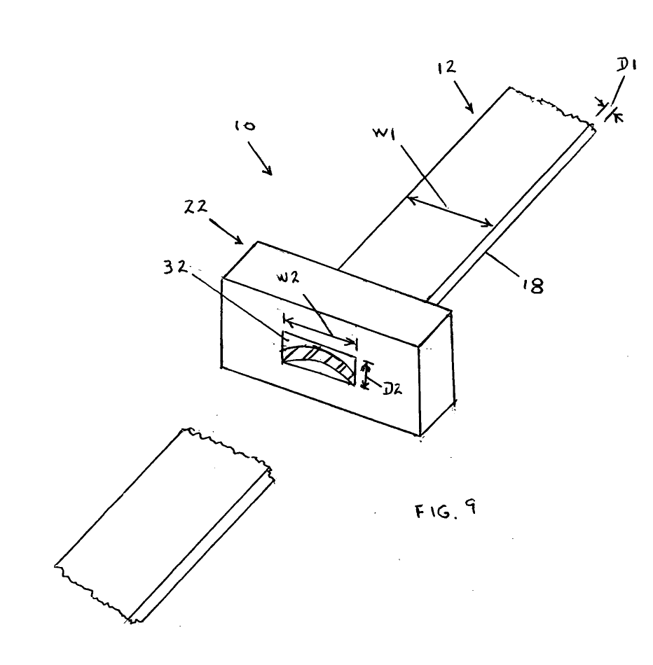

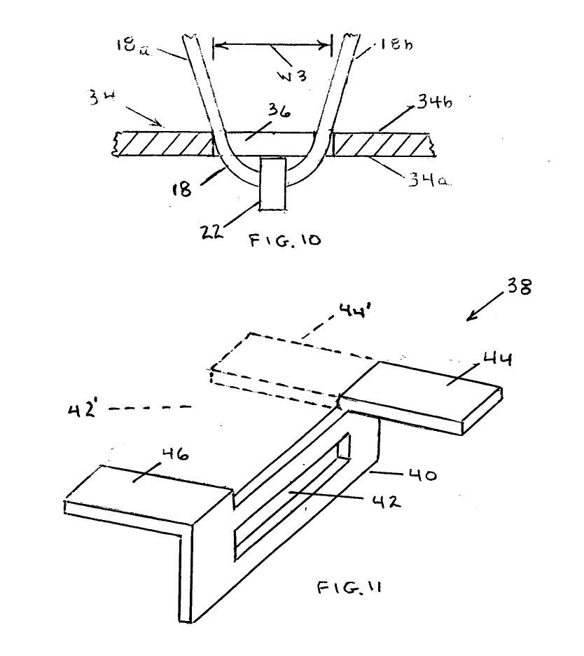

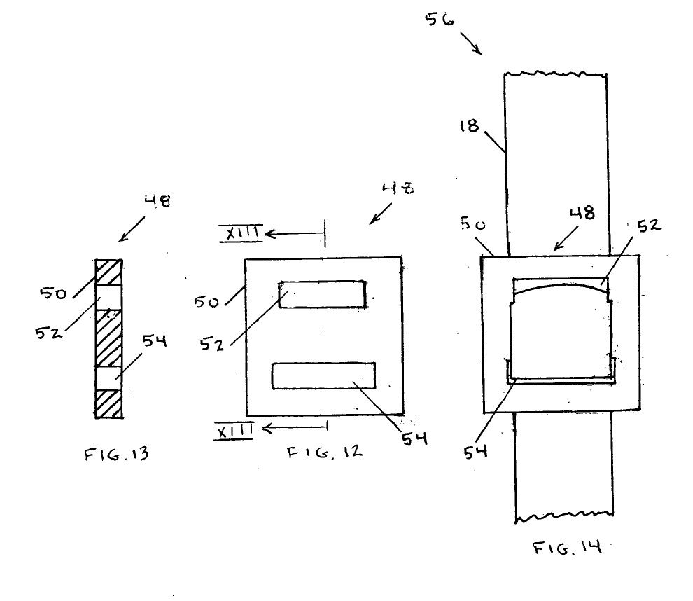

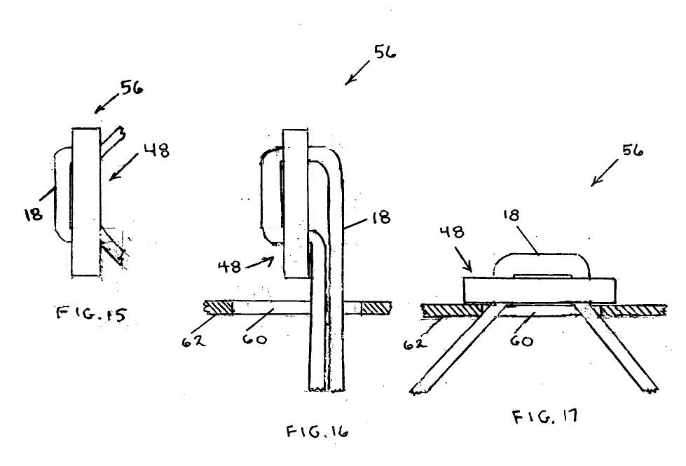

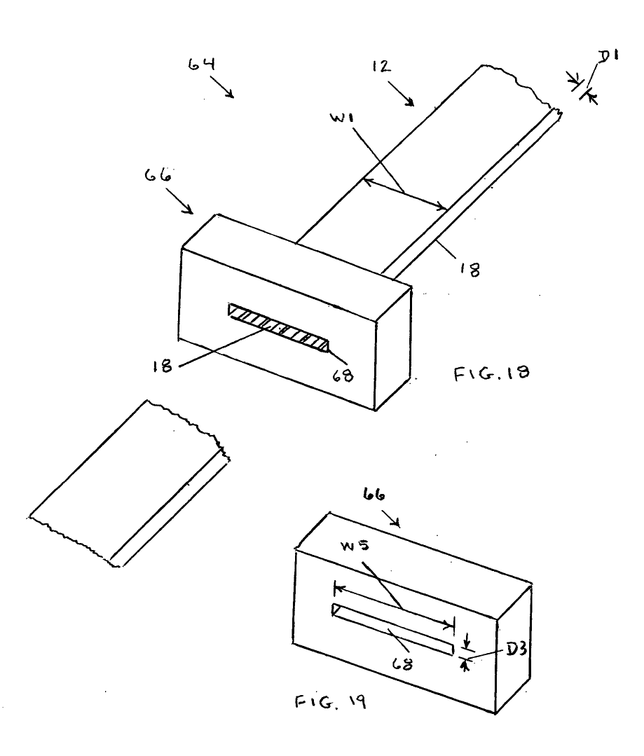

Referring to FIGS. 2-5, securement member 22 has top surface 24, bottom surface 26, front surface 28 and rear surface 30, with aperture 32 extending therethrough and opening into front surface 28 and rear surface 30. Securement member 22 is an elongate, rigid body, comprised of plastic, metal, etc.

In the sectional view of FIG. 6, cable tie 18 is shown to have a width or transverse dimension W adjacent its free end. In the sectional view of FIG. 7, cable tie 18 is shown to have a dimension W1 generally along its length.

In the sectional view of FIG. 8, securement member 22 is sectioned, as is tail 18. Aperture 32 will be seen to have a width dimension W2. Per the invention, aperture width dimension W2 is selected to be less than tail width W1 and in excess of tail width dimension W, whereby tail 18 can freely enter aperture 32 and be pulled longitudinally of the tail part through aperture 32 until the tail with width W1 confronts aperture width dimension W2 and preferably pulled therebeyond through the aperture until the center of the tail is resident in the aperture. Tail 18 is forced to assume the arcuate tail configuration shown in FIG. 8, whereupon the horizontal force component of the tail self-bias to a planar condition causes the tail to abut the left and right side margins of aperture 32 and develop a friction-fit therewith. There thus exists a securement of cable tie tail 18 and securement member 22, whereby they are portable with one another.

The various width dimensions are also seen in FIG. 9, along with thickness or height dimensions in accordance with the invention. Cable tie tail 18 has a thickness dimension of D1. To facilitate the deformation of tail 18 into arcuate configuration and the friction-fit thereof in aperture 32, aperture 32 has a height dimension D2 selected to be in excess of dimension D1. Manifestly, the height dimension of securement member 22 need only be in excess of dimension D2 and may be less than the height dimension shown in FIG. 9 to facilitate dense packing for shipping of the assembly of cable tie and securement member.

In the assembly of FIG. 10, securement member 22 extends lengthwise into the plane of FIG. 10, bearing on the rear (lower) surface 34a of mounting panel 34 under a force deriving from the longitudinal self-bias of the now folded tail 18. Courses 18a and 18b of the tie extend through mounting panel opening 36 beyond front (upper) surface 34b of the mounting panel to receive conductors to be ensnared. As will be appreciated, the transverse self-bias of tail 18 friction-fits the tail to securement member 22, as above discussed. Thus, per the invention, use is made of both the longitudinal and transverse components of the self-bias of the tie to a planar condition.

The invention contemplates reaching the FIG. 10 assembly by insertion of the assembled cable tie and securement member from the rear (lower) surface 34a of the mounting panel.

In so assembling from the rear side of the mounting panel, the tail is folded and both the cable tie head and the tail free end are passed through the mounting panel opening, whose diameter is selected to have width (W3) greater than the width W4 (FIG. 1) of the cable tie head.

Turning to FIG. 11, a further securement member 38 in accordance with the invention is shown to include central plate 40 defining through aperture 42, and tongues 44 and 46 extending orthogonally outwardly of central plate 40. The width of the plate and that of its aperture are again chosen such that the cable tie tail is frictionally retained in the aperture by a force derived from arcuately shaping the tail and using the horizontal component of the tail self-bias to a planar condition.

In assembling securement member 38 with mounting panel 34 of FIG. 10 tongues 44 and 46 bear against the mounting panel rear surface, at least partly under force derived from the longitudinal component of the cable tie tail self-bias to a planar condition.

Referring to FIGS. 12 and 13, securement member 48 of the invention is comprised of rigid plate member 50, again of plastic, metal, etc., and defines first aperture 52 extending therethrough and of width W2, greater than the width W1 of the cable tie tail and of height D2, exceeding the thickness dimension D1 of the cable tie (FIGS. 7-9).

Second aperture 54 also extends through plate member 50 and is of dimensions, width and height, slightly exceeding the width and thickness of the cable tie tail to permit free movement of the tie therethrough. The assembly 56 of FIG. 14 is reached by inserting cable tie 18 into first aperture 52 to become frictionally secured to securement member 48. The course of the tail extending beyond the first aperture is now dressed into and through second aperture 54. A left side elevation of assembly 56 is seen in FIG. 15.

The upper course of tail 18 in FIG. 14 is now dressed downwardly, as shown in FIG. 16, into contact with the lower course of tail 18. This assembly 58 is now inserted into mounting panel opening 60 of mounting plate 62, as also shown in FIG. 16.

The two courses of the tail are now displaced jointly leftwardly in FIG. 16 to the center of mounting panel opening 60 and pulled downwardly. This results in the configuration shown in FIG. 17, wherein securement member 48 moves into engagement with mounting plate 62 under the influence of both the transverse and longitudinal components of the tail self-bias to a planar condition.

As will be appreciated, assembly 58 may be inserted into mounting panel opening 60 from either side of the mounting panel.

Turning to FIGS. 18 and 19, further assembly 64 in accordance with the invention employs securement member 66. As is seen in FIG. 19, securement member 66 defines aperture 68 extending therethrough. To facilitate the deformation of tail 18 into a lesser thickness and the friction-fit thereof in aperture 68, aperture 68 has a height dimension D3 selected to be less then tail thickness dimension D1. Aperture 68 has a width (W5) exceeding width W1 of cable tie tail 18 such that, as tail thickness is lessened, the tail may expand widthwise. Aperture 68 may be preformed to such height D3 or may be deformed to such dimension after receiving the cable tie tail, e.g., by a crimping tool.

Various changes may be introduced in the disclosed preferred embodiments and practices without departing from the invention. By way of example, referring to FIG. 1, securement member 38 may be modified to extend tongue 44 as is indicated in phantom at 44, defining further opening 42′ of width exceeding the width of the cable tie tail and permitting insertion of the resulting securement member from the front side of a mounting panel as shown in FIG. 16. Accordingly, it is to be appreciated that the true spirit and scope of the invention is set forth in the following claims.

What is claimed is:

1. A securement member for mounting a cable tie to a mounting panel, the cable tie being an elongate member having a head and a tail extending from the head, the securement member comprising a rigid elongate body defining an aperture extending therethrough, the aperture being adapted to receive the tail longitudinally of the body and being of lesser dimension than a tail dimension in one of tail width and height to frictionally engage the received tail.

2. The securement member claimed in claim 1, wherein said tail has a given transverse dimension and a given thickness, said aperture having a height dimension of a dimension exceeding said tail given thickness and a dimension transversely of said received tail less than said tail given transverse dimension.

3. The securement member claimed in claim 1, wherein said tail has a given transverse dimension and a given thickness, the aperture receiving the tail having a width at least equal to the transverse dimension of the tail and a height dimension less than the tail thickness.

4. The securement member claimed in claim 2, wherein said body defines a further aperture extending therethrough and adapted to receive said tail, said further aperture having a height dimension at least equal to said tail thickness and a dimension transversely of said received tail exceeding said transverse dimension of said received tail.

5. The securement member claimed in claim 4, wherein outermost margins of said first-mentioned and said further apertures are adapted to frictionally engage said received tail.

6. A method for use in assembling conductors with a mounting panel, comprising the steps of:
(a) providing a cable tie having a head and an elongate tail extending from said head, said tail having a self-bias to a planar condition;
(b) attaching a securement member to said tail using the self-bias of said tail to render said securement member portable with said cable tie; and
(c) while maintaining the biased attachment of said securement member and said tail, attaching said securement member and said cable tie to said mounting panel using the self-bias of said tail.

7. The method claimed in claim 6, wherein said step (b) is practiced by using a component force of said self-bias of said tail which is transverse to said tail to affect said attachment of said securement member to said tail.

8. The method claimed in claim 7, wherein said step (b) is further practiced by using a component force of said self-bias of said tail which is longitudinal of said tail to affect said attachment of said securement member to said tail.

9. A method for use in part in assembling conductors with a mounting panel, comprising the steps of:
(a) providing a cable tie having a head and an elongate tail extending from said head, said tail having a self-bias to a planar condition; and
(b) attaching a securement member to said tail using one of a width and a height component of said self-bias of said tail to render said securement member portable with said cable tie.

10. The method claimed in claim 9, wherein said step (b) is practiced by providing said securement member as a rigid body defining an aperture extending therethrough and configured to have margins transversely spaced from one another by a distance less than a width of said tail resident in said aperture.

11. The method claimed in claim 9, wherein said step (b) is practiced by providing said securement member as a rigid body defining an aperture extending therethrough and configured to have margins spaced in height from one another by a distance less than a thickness of said tail resident in said aperture.

12. The method claimed in claim 10, including the further step of providing a further aperture extending through said securement member and configured to have margins transversely spaced from one another by a distance at least equal to said width of said tail resident in said further aperture.

13. The method claimed in claim 11, including the further step of providing a further aperture extending through said securement member and configured to have margins spaced transversely spaced from one another by a distance at least equal to said width of said tail resident in said further aperture.
